(19) United States
(12) Patent Application Publication
(10) Pub. No.: US 2012/0265549 A1
(43) Pub. Date: Oct. 18, 2012

(54) System and Computer Readable Medium for Predicting Patient Outcomes

(75) Inventor: Isto Virolainen, Helsinki (FI)

(73) Assignee: General Electric Company, Schenectady, NY (US)

(21) Appl. No.: 13/085,071

(22) Filed: Apr. 12, 2011

(51) Int. Cl. G06Q 50/00

(52) U.S. Cl. 705/2

(57) ABSTRACT

A processor operates to predict an outcome of a patient. Current physiological information is received from a patient. A similar patient subset is retrieved and the current physiological information is compared to the historical physiological information of the historical records of the similar patient subset. A correspondence is rated between the current and historical physiological information. A selection is made between a first outcome and a second outcome based upon the ratings of the correspondences and a notification is presented that is indicative of the selected first or second outcome.

### BACKGROUND

The present disclosure relates to the field of automated patient diagnosis. More specifically, the present disclosure relates to predicting a patient outcome.

Effective medical care demands that limited hospital physical resources such as intensive care unit (ICU) beds, general care beds, and home-based patient care systems be properly matched with patient needs such that the patient receives necessary medical treatment while avoiding the excessive use of medical care resources that are more time and resource intensive, and therefore expensive when the patient does not require these additional resources. Effective management of hospital resources can lead to improved access for patients to the scarce hospital resources, while reducing the cost of treatment of a patient by minimizing the use of expensive resources.

### BRIEF DISCLOSURE

A non-transient computer readable medium is programmed with computer readable code that upon execution by a processor causes the processor to receive physiological information about a patient. The processor retrieves a similar patient subset that includes a plurality of historical records. The processor compares the physiological information from the patient to the historical records of the similar patient subset and rates a correspondence between the physiological information of the patient and the historical physiological information of the historical records. The processor selects between a first outcome and a second outcome based upon the ratings of the correspondences and presents a notification that is indicative of the selected first or second outcome.

In an alternative embodiment, a non-transient computer readable medium is programmed with computer readable code that is executed by a processor and causes the processor to receive demographic information about the patient and receive diagnosis information about the patient. The processor filters a database that includes a plurality of historical records to create a similar patient subset. Each historical record of the plurality includes historical demographic information, historical physiological information, and a historical outcome. The historical outcome is either a critical outcome or a recovery outcome. The similar patient subset includes historical records from the plurality of historical records in which the demographic information about the patient is similar to the demographic information in each of the historical records of the similar patient subset. The processor filters the similar patient subset based upon a diagnosis information about the patient to limit the historical physiological information used from each of the historical records of the similar patient subset. The processor separates the similar patient subset into a critical outcome group and a recovery outcome group based upon whether the historical record at a critical outcome or a recovery outcome. The processor defines a critical outcome path based upon the historical physiological information of the historical records of the critical outcome group. The processor defines a recovery outcome path based upon historical physiological information on the historical records of the recovery outcome group. The processor receives current physiological information from the patient and compares the current physiological information from the patient to the critical outcome path and the recovery outcome path. The processor rates the correspondence between the current physiological information from the patient and each of the critical outcome path and the recovery outcome path and selects between the critical outcome path and the recovery outcome path based upon the ratings of the correspondences. The processor presents a notification indicative of the selected critical outcome path or the recovery outcome path.

A system for predicting an outcome of a patient includes a match candidate database. The match candidate database is stored on a computer readable medium and includes a plurality of historical records. Each historical record of the plurality includes historical physiological information and historical outcome. A graphical display is configured to present a notification of a predicted outcome of the patient. The processor is communicatively connected to the match candidate database and the graphical display. The processor compares the physiological information from the patient with the historical physiological information from the plurality of historical records and rates a correspondence between the physiological information from the patient and the historical records. The processor uses the rated correspondence to determine a predicted outcome of the patient. The processor operates the graphical display to present the notification of the predicted outcome of the patient and an associated correspondence used to determine the predicted outcome of the patient.

### BRIEF DESCRIPTION OF THE DRAWINGS

FIG. 1 depicts an embodiment of a system for predicting a patient outcome.

FIG. 2 is a schematic diagram of a process to predict patient outcome.

FIG. 3A is a flow chart that depicts an embodiment of a method of predicting patient outcomes.

FIG. 3B is a flow chart that depicts an embodiment of a sub-method of predicting a patient outcome.

FIG. 4 is a schematic diagram that depicts a more detailed embodiment of a process to rate a correspondence between current physiological information and historical physiological information.

### DETAILED DISCLOSURE

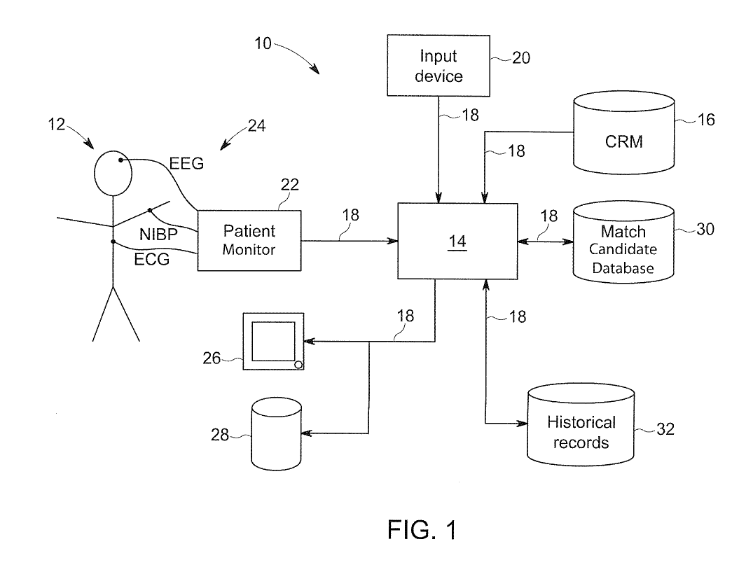

FIG. 1 is an embodiment of a system 10 for predicting a medical outcome of a patient 12.

A processor 14, which in embodiments may be a component of a personal computer or a server, is communicatively connected to a computer readable medium 16 that is programmed with computer readable code that is read and executed by the processor 14. The execution of the computer readable code stored on the computer readable medium 16 by the processor 14 causes the processor to perform the processes and functions as described in further detail herein.

The processor 14 and the computer readable medium 16 are connected by a communicative connection 18. In embodiments of the system 10, the processor 14 is connected to each of the components in the system 10 with a communicative connection 18. In embodiments of the system 10, each of the communicative connections 18 can be wired or wireless connections between the components. Therefore, the system 10 can take a variety of physical embodiments ranging from one embodiment in which the entire system 10 is contained within a physical device, and in such an embodiment all of the communicative connections 18 would be wired connections. Alternatively, the system 10 may be an embodiment in which each of the components as disclosed herein are distributed across a communication network (not depicted), and the communicative connections 18 include a variety of wired and wireless communicative connections such as would be recognized by one of ordinary skill in the art would recognize suits the particular implementation of that embodiment.

The system 10 includes an input device 20, which exemplarily may be a keyboard, a mouse, a touch screen, or other input device as recognized by one of ordinary skill in the art that is operated by a clinician to input data and to make requests and otherwise operate the processor 14 as it carries out the instructions of the computer readable code.

A patient monitor 22 is communicatively connected to the patient 12 with a plurality of transducers that obtain physiological information 24 from the patient 12. The physiological information 24 obtained from the patient, can exemplarily include, but is not limited to, electrocardiograph (ECG), electroencephalograph (EEG), and blood pressure, such as may be obtained using a non-invasive blood pressure (NIBP) technique. In still further embodiments, it is understood that the physiological information can further include, but not be limited to, patient temperature, blood oxygen saturation (SPO2), respiration rate or other ventilatory parameters, and lab results. Still further examples of physiological information, may include information that which is derived from parameters obtained directly from the patient, or are a processed form of the physiological parameters. Examples of this physiological information include ECG morphology analysis, such as arrhythmia detection, or ECG timing intervals, such as Q-T intervals.

The processor 14 is further connected by a communicative connection 18 to a graphical display 26. The graphical display 26 is operated by the processor 14 in order to present information. The processor 14 may operate the graphical display 26 in a manner such as to present acquired physiological information 24, inputs entered by the clinician into the input device 20, and any results obtained as disclosed herein in further detail by the execution of the computer readable code from the computer readable medium 16 by the processor 14.

The processor 14 is also connected by a communicative connection 18 to a memory 28. The memory 28 may be any of a variety of non-volatile or other memory as would be recognized by one of ordinary skill in the art. The memory 28 receives and stores information as disclosed herein from the processor 14. The information received and stored by the memory 28 may include, but is not limited to, physiological information 24 obtained from the patient 12 and/or the results from the functions of the processor as disclosed in further detail herein.

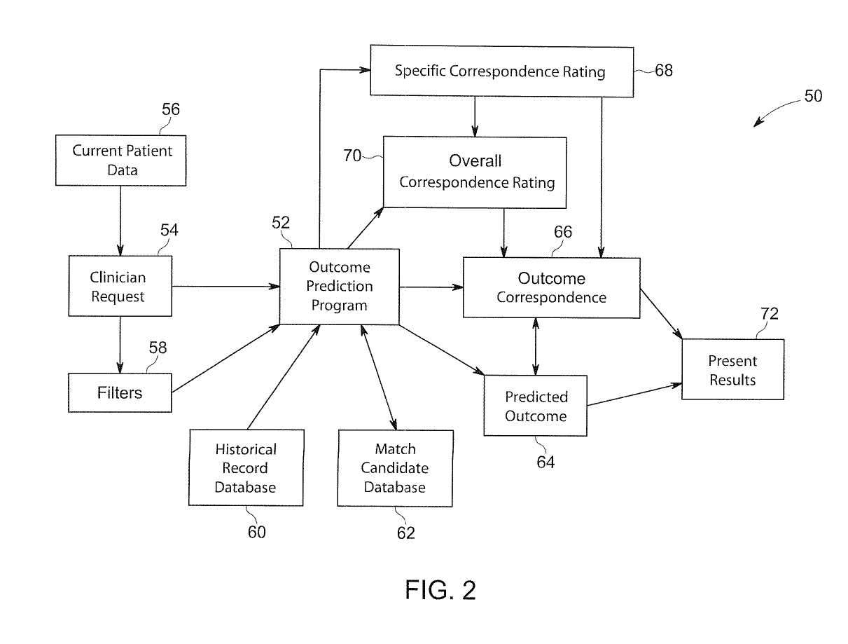

As will be described in further detail with respect to FIGS. 2-4, the system 10 depicted in FIG. 1 operates by the processor 14 executing the computer readable code stored on the computer readable medium 16 in order to function in a manner as described herein. The processor 14 operates in two general functions. In a first function, the processor 14 retrieves historical records from a database of historical records 32 to which the processor 14 is connected by a communicative connection 18. The processor 14 filters the retrieved historical records from the historical records database 32 to arrive at a similar patient subset out of the plurality of historical records in the historical record database 32. The similar patient subset is stored in a matched candidate database 30 that is connected by a communicative connection 18 to the processor 14. The processor 14 relies upon the similar patient subset stored in the matched candidate database 30 for any query by the clinician for a predicted patient outcome. Alternatively, the processor 14 may operate to routinely perform predictions of patient outcome as requested by the clinician at regular intervals.

The processor 14 operates in accordance with the computer readable code to produce a predicted outcome of the patient by first retrieving the similar patient subset that was created for the specific patient 12 and is stored in the matched candidate database 30. The processor 14 then receives the current physiological information 24 from the patient monitor 22. The processor 14 divides the similar patient subset into at least two outcome paths. In general, as will be described in further detail herein, these outcome paths may be characterized as a critical or negative outcome that is associated with a down grade of patient condition to more intensive medical resources, or ultimately, patient death, while the other outcome path is characterized as a positive or recovery outcome path that is characterized by a patient up grade to less intensive medical resources and patient recovery and release.

The processor 14 compares the current physiological information 24 of the patient 12 to each of the historical records in the similar patient subset and rates a correspondence between the current physiological information from the patient and the physiological information in each of the historical records. After rating the correspondence between the current patient physiological information and the physiological information in each of the historical records of the critical outcome path and the recovery outcome path of the similar patient subset, the processor 14 selects between the critical outcome historical records and the recovery outcome historical records based upon which historical records exhibit greater correspondence to the current patient physiological information. The processor 14 produces a notification of the selected outcome path and operates the graphical display 26 to present the notification. The processor also causes the selected outcome to be stored in the memory 28. Over the course of a treatment of the patient 12, a plurality of outcome predictions may be made and the storage of each of these outcome predictions along with date, time, and other identifying information enables a clinician to track or otherwise trend the development of the patient's predicted outcome over time.

FIG. 2 is a schematic diagram of the process that occurs in an embodiment of predicting a patient outcome. The schematic diagram 50 centers around the outcome prediction program 52 which may be embodied in computer readable code that is stored on a computer readable medium as described above with respect to FIG. 1.

The schematic diagram 50 includes a clinician request 54 to initiate a prediction of the outcome of the patient. The clinician request 54 relies upon, at least in part, the current patient data 56. The current patient data 56 includes both currently obtained physiological parameters, such as, but not limited to, ECG, SPO2, respiration rate, blood pressure or others as described above, but also includes patient data that may be obtained from a patient's electronic medical record (EMR). This additional patient data 56 may include patient demographics such as age, height, weight, sex, ethnicity, personal health habits such as smoking or alcohol use. Furthermore, the current patient data includes a current diagnosis of the patient, which in embodiments is stored in the electronic medical record.

In some embodiments, the clinician request 54 identifies a specific time period of patient and historic data for review as disclosed herein in making the determined outcome predictions. Alternatively, the time period may be determined by the current patient data 56, as in one embodiment the time period is less than or equal to the amount of current patient data available for review. In a still further embodiment, the clinician request identifies a trend length that is representative of the temporal period within which the system 50 will make a patient prediction. In such an embodiment, a clinician request 54 with a trend length of six hours will predict the patient outcome over the next six hours. Likewise, a trend length of two hours, 12 hours, or 24 hours will result in a prediction of a patient outcome within those time frames.

The clinician request 54 and the current patient data 56 are used by the outcome prediction program 52 to select a plurality of filters 58 that are used in identifying the similar patient subset that is used for the outcome prediction.

The outcome prediction program 52 has access to a plurality of historical medical records in a historical records database 60. The historical records in the database can be acquired by a medical facility over time, or may similarly be developed by a consortium of interests that share the medical record of actual historical patients. It is understood that in order to comply with medical information security laws, the historical records in the historical record database are scrubbed of any identifying information, and only the required physiological information as disclosed herein would be present in the historical record database.

In one embodiment, each historical record of the historical record database 60 includes general demographic information of the patient, stored physiological parameter trends and/or actual stored physiological data of the patient leading up to a clinician identified outcome, a diagnosis, the outcome of the patient, and a brief explanation of the outcome. In the historical record, the identified outcome may be a binary indication of a positive or recovery outcome or a negative or critical outcome. The explanation may then further clarify the outcome by identifying, for a recovery outcome, whether the recovery was reducing the medical intervention provided to the patient (e.g. transfer from ICU to general recovery) or patient discharge all together. If the outcome is a critical outcome, the brief explanation may identify whether the patient was removed for more intensive treatment, hospice care, or death.

As mentioned above, the outcome prediction program 52 uses a plurality of filters 58 to sort through all of the historical records in the historical record database 60 to create a similar patient subset. The filters 58 used to create this similar patient subset include filters that sort for patient demographics or patient diagnosis. Based upon the patient diagnosis or the available physiological parameters in the current patient data 56, a filter 58 selects only those historical records that are similar to the current patient either based upon diagnosis, demographics, monitored parameters, or a combination of the above. Finally, a trend length as described above from the clinician request may identify only those portions of the physiological data of the historical records that is within the designated trend length.

Once the similar patient subset is created for the current patient, the similar patient subset can be stored in the matched candidate database 62 for future or recurring patient outcome predictions. This saved similar patient subset can be used in subsequent outcome predictions so long as the information used to filter the historical record database remains valid for the patient.

The outcome prediction program 52 begins with a predicted outcome 64, exemplarily a recovery outcome. The outcome prediction program 52 pulls all of the historical records from the similar patient subset that include a recovery outcome. These historical records are processed by the outcome prediction program to rate a correspondence of the historical record with the predicted outcome 64 to the current patient data 56. This outcome correspondence 66 can then be presented along with the predicted outcome 64 to notify a clinician of both the predicted outcome and the correspondence rating. In a merely exemplarily embodiment, the results presented at 72 may indicate that the patient is predicted to follow a recovery outcome with a 45% rate of correspondence between the recovery outcome and the current patient data.

Similarly, the outcome prediction program can operate through the same procedure to determine the outcome correspondence 66 for a predicted critical outcome 64. In one embodiment, the determined outcome correspondence rating is presented for both of the potential outcomes. In an alternative embodiment, only the predicted outcome with the highest overall correspondence rating is presented in a notification to the clinician.

The outcome correspondence rating 66 can be derived in a variety of ways, which will be described in further detail later herein. In one embodiment, an overall correspondence rating is derived by comparing the current patient data 56 to the historical data of the similar patient subset. As will be described in further detail herein, the overall correspondence rating 70 is based upon generalization of the overall record or base information contained in the records themselves, such as demographics, or risk factors.

In an alternative embodiment, a specific correspondence rating 68 is derived which can be used on its own to produce the outcome correspondence rating 66 or can be an input into the overall correspondence rating 70. Examples of specific correspondence rating 68, as will be described in further detail herein, include a parameter by parameter comparison between the current patient data 56 and the physiological data of the historical record in the similar patient subset. Thus, the specific correspondence ratings 68 may be a plurality of ratings in which the correspondence between individual physiological parameters of the patient and the historical records are comparatively evaluated.

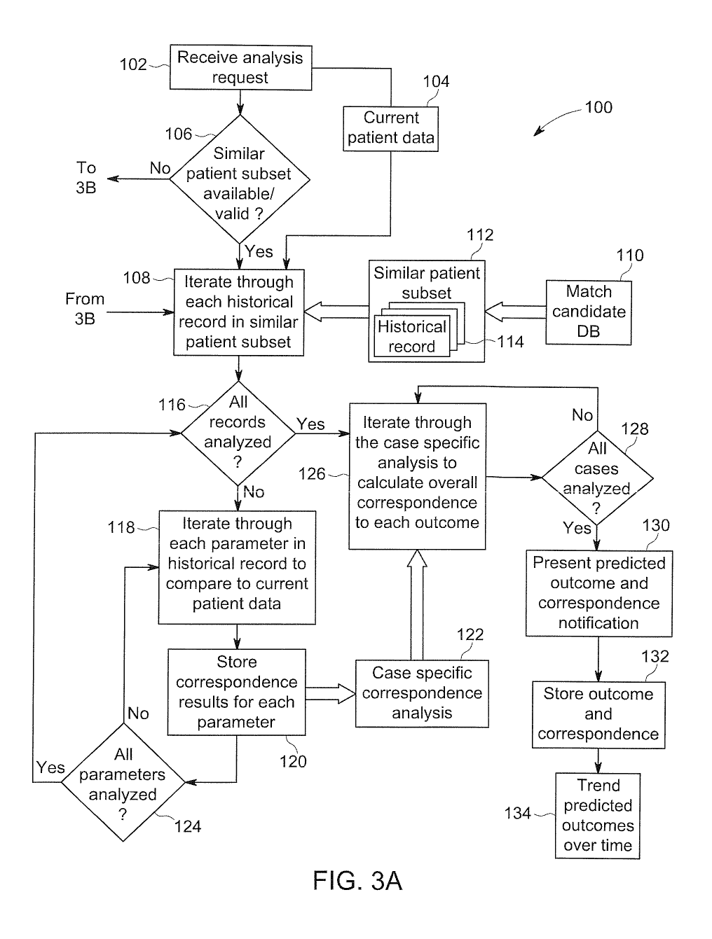

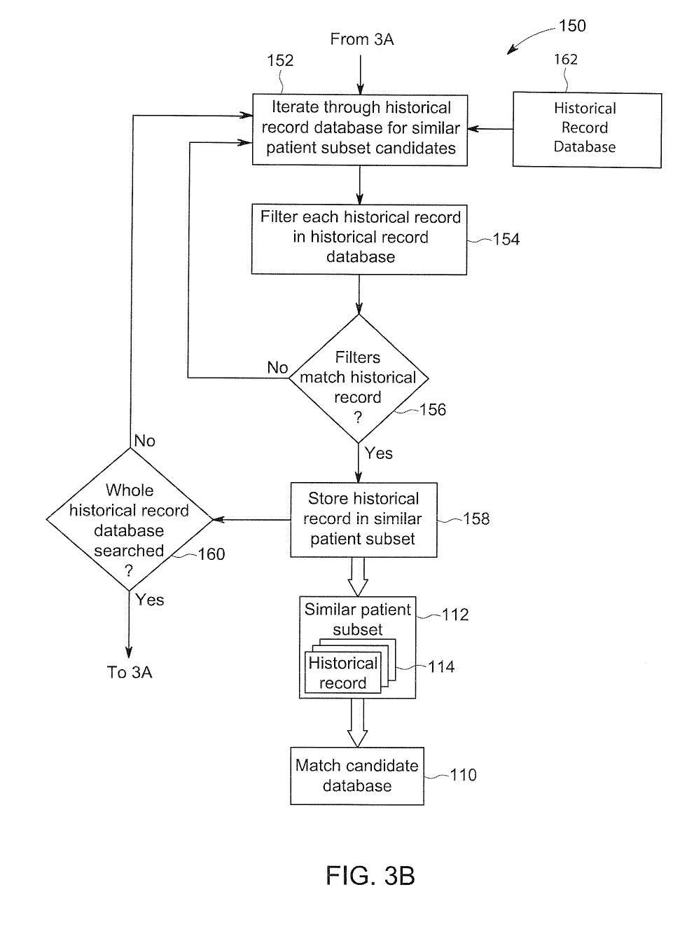

FIG. 3 is a flow chart that depicts an embodiment of a method of predicting a patient outcome as disclosed herein. The method 100 begins when an analysis request is received at 102. The analysis request can come from a clinician or may alternatively be an automated request such that a prediction of a patient outcome is determined at regular intervals.

The analysis request received at 102 can include patient identification information, current patient data 104, and an indication of a requested trend length. The requested trend length is used in the method 100 to establish the time for the predicted patient outcome. Thus, if the requested trend length is two hours, then the method will produce a prediction of the patient outcome over the next two hours. If the trend length is requested at 12 hours, then the method will predict the patient's outcome within the next 12 hours. It is understood that the trend length can be set to any amount of time to which the method has access to historical physiological data of that duration prior to an outcome. Alternatively, it is understood that the trend length could be established as a default by a particular clinician or medical institution.

After the analysis request is received at 102, at 106 a determination is made whether a similar patient subset is available and valid for the current patient. As will be described in further detail herein with respect to FIG. 3B, a similar patient subset is created and stored for each patient. Once the similar patient subset has been created, it may be reused in subsequent performances of the method, so long as the similar patient subset remains valid for the conditions of the patient. The similar patient subset may be determined to be invalid if, for example, the patient's diagnosis changes.

Assuming for the continued discussion of FIG. 3A that the similar patient subset is available and valid, at 108 each historical record in the similar patient subset is iterated through to evaluate the current patient data 104 in view of the historical records of the similar patient subset. A matched candidate database 110 stores all of the similar patient subsets 112 that have been created with embodiments of the method as disclosed herein. Each similar patient subset 112 is specific to a patient and characterizes a plurality of historical records 114 that have been selected for identified similarities between that historical record and the current patient. The similar patient subset is retrieved from the match candidate database 110.

In iterating through each historical record in the similar patient subset at 108, a determination is made at 116 whether all of the historical records have been analyzed. If there are still historical records in the similar patient subset that need to be analyzed, then at 118 each historical record is broken down into the separate physiological parameters stored in the historical record and each physiological parameter in the historical record is iterated through to compare to a comparable physiological parameter in the current patient data 104.

As noted above, the trend length may be received as part of the analysis request 102. The trend length is used in embodiments at 118 in order to determine the temporal length of the physiological parameter data from a historical record to be analyzed. The process at 118 results in a determination of a correspondence between the current patient physiological parameter data and the data of the same physiological parameter in the historical record. The correspondence results for each parameter are stored at 120. The correspondence results for each physiological parameter are stored at 120 in a database of case specific correspondence analysis 122 where the correspondence results are stored until they are used as will be described in further detail herein.

At 124, a determination is made whether or not all of the physiological parameters in the historical record have been analyzed. If all of the physiological parameters in a historical record have been compared to a corresponding physiological parameter of the current patient data, then the method 100 returns to 116 to continue to iterate through each of the historical records in the similar patient subset. In an embodiment, the historical record includes data for more physiological parameters than are available in the current patient data. In that embodiment, it is understood that the correspondence analysis is limited by the currently available physiological parameters, and some of the historical physiological parameters may not be used.

If all of the historical records 114 of the similar patient subset 112 have been analyzed, then the method 100 proceeds to 126 where all of the stored correspondence results from the case specific correspondence analysis database 122 are iterated through to calculate an overall correspondence between the current patient data and each of the historical records 114 in the similar patient subset 112. The overall correspondence between the current patient data and each of the historical records 114 is determined by aggregating the correspondence analysis stored for each of the physiological parameters in the historical record as previously determined and stored in the case specific correspondence analysis database 122. Thus, the overall correspondence provides an indication of the quality of the physiological match between the current patient data and each of the historical records 114 in the similar patient subset 112.

Once it has been determined at 128 that an overall correspondence has been calculated for each of the historical records, a notification of the predicted outcome and the calculated correspondence is presented at 130. The notification of the predicted outcome and overall correspondence can be presented in a variety of ways. In an embodiment, as described above, the alternative outcomes may be a critical outcome or a recovery outcome. In one embodiment, only the outcome with the higher calculated overall correspondence between the current patient data and the historical records exhibiting that outcome is presented. The correspondence between the current patient data and the historical records exhibiting that outcome is presented in the notification. In an alternative embodiment, both the critical outcome and the recovery outcome are presented in the notification along with the calculated correspondence between the current patient data and the historical records of patients that experienced a critical outcome and those patients that experienced a recovery outcome.

In the embodiment of the notification wherein only the outcome with the greater overall correspondence is presented, the method 100 operates in a more diagnostic manner, presenting the clinician with the derived predicted outcome, and a rating of the quality of that prediction (in the form of the calculated correspondence). In the alternative embodiment that presents both outcomes and associated correspondences, the method 100 operates more to inform the clinician by presenting the correspondence rating for both of the potential patient outcomes.

At 132, the predicted outcome and the calculated overall correspondence is stored for future use and reference. In one embodiment, the predicted outcome and calculated correspondence are stored in the patient's EMR. Finally, at 134 the predicted outcomes can be trended over time to develop an additional view of patient progression. This is particularly applicable to embodiments of the method wherein the outcome prediction analysis is requested at regular intervals, such as in an automated system that performs regular outcome prediction analysis.

Referring now to FIGS. 3A and 3B, if at 106 (FIG. 3A) no similar patient subset is determined to be available and/or valid for the current patient, then the method 100 continues with sub-method 150, an embodiment of which is depicted in FIG. 3B. Sub-method 150 is an embodiment of a process used to create a similar patient subset for the current patient, if one has not already been created, or if a previously created similar patient subset is no longer valid due to changes in the condition of the patient. In an embodiment, the sub-method 150 may alternatively be used to create a new similar patient subset if the historical records database 162 has been updated with new historical records. An update of new historical records may reflect improved patient outcomes brought about by new techniques of treatments.

At 152, a historical record database 162 is iterated through to identify similar patient subset candidates. This is achieved in 154 by filtering each historical record from the historical record database 162 with filter criteria that are indicative of the current patient. These filter criteria may include patient demographics such as age, sex or ethnicity, weight, height, known preexisting conditions, or diagnosis; however, a person of ordinary skill in the art will recognize other filter criteria that may be used to select historical records for the similar patient subset. As briefly disclosed above, the historical record database 162 is populated with a plurality of historical records that have been scrubbed of identifying information. A healthcare facility or other medical institution can develop a historical record database by compiling the scrubbed records of all patents that reach an outcome. The historical records are added to the historical record database 162 upon a patient reaching an outcome. Once a critical outcome or a recovery outcome is reached, a clinician or other administrative personnel creates the historical record by removing identifying information from the record and entering the outcome that the patient experiences. In some embodiments, the historical record also includes a further brief description of the outcome or other notes relating to the patient outcome. It is understood that in some embodiments, the historical records in the historical record database 162 are compiled by the healthcare provider over the course of days, weeks, or years of patient treatments and outcomes. Alternatively, the historical record database 162 can be supplied by an outside supplier or vendor that compiles historical records from a plurality of healthcare facilities.

It is to be recognized that in some embodiments, the quality and correspondence between the current patient data and the predicted outcome can be improved with the use of a historical record database 162 with more historical records. Therefore, in one embodiment, the historical record database 162 includes 1,000 historical records, while in an alternative embodiment, the historical record database 162 comprises 1 million or more historical records; however, this is not intended to be limiting on the scope of the sizes of the historical record databases disclosed herein.

At 156, a determination is made whether the filter criteria match the data of the historical record. If the filters do not match the data of the historical record, then the process continues to iterate through the historical record database 162 for matching historical records. If the historical record data matches the filter criteria, then the historical record 114 is stored at 158 in a similar patient subset 112. The similar patient subset 112 is stored in the matched candidate database 110 for later retrieval by the method as disclosed and described in further detail above with respect to FIG. 3A.

After the historical record 114 is stored in the similar patient subset at 158, a determination is made at 160 whether the whole historical record database 162 has been searched. If the whole historical record database 162 has not been searched, then the subset 150 continues with 152 to iterate through the historical record database 162. However, if the whole historical record 162 database has been searched at 160, then the sub-method 150 returns to the method 100 depicted in FIG. 3A to determine a predicted outcome for the current patient using the newly created similar patient subset 112.

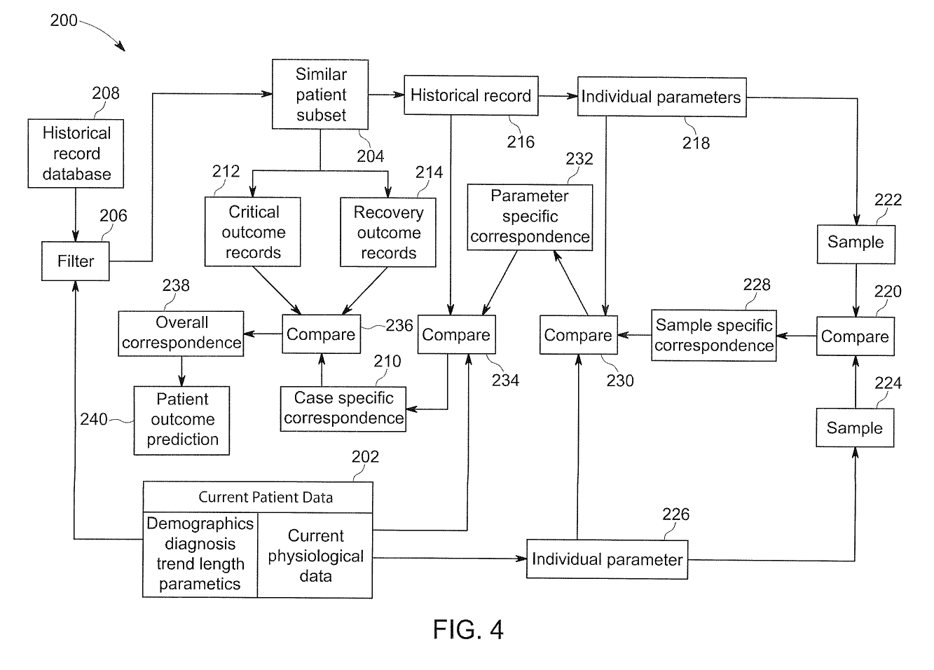

FIG. 4 is a schematic diagram 200 of a more detailed embodiment of a process to rate the correspondence between the current patient data 202 and the historical records of the similar patient subset 204.

As disclosed previously, the current patient data 202 includes both stored patient data such as the patient demographics, diagnosis, a requested trend length for the outcome prediction, and selected physiological parameters for the outcome prediction. The current patient data 202 also includes the currently monitored physiological data obtained from the patient. The stored patient data are used at 206 to filter the historical records of the whole historical record database 208 to identify the historical records of the similar patient subset 204. These features are described in more detail above with respect to the sub-method 150 shown in FIG. 3B.

The current physiological data of the current patient data 202 and the historical records of the similar patient subset 204 are compared to determine a correspondence between the current patient physiological data 202 and the historical records of the similar patient subset 204 in order to arrive at a notification of a predicted patient outcome. It is to be understood that in embodiments herein, the similar patient subset 204 can either be initially divided by the outcomes of the historical records therein and the correspondence determinations performed on the subsets based upon patient outcome.

Alternatively, as depicted in FIG. 4, the similar patient subset 204 is processed to determine a case specific correspondence 210 for each historical record 216 of the similar patient subset 204 and then the historical records 216 of the similar patient subset 204 are divided into critical outcome records 212 and recovery outcome records 214 and a final determination is made based on the case specific correspondence and the two groups of outcome records.

Each historical record 216 is retrieved from the similar patient subset 204. The individual physiological parameters 218 from the historical record 216 are each analyzed in turn. In determining a correspondence for each historical record 216, a sample-by-sample comparison is made at 220 between the samples 222 of each individual physiological parameter 218 of the historical record 216 and the samples 224 of a corresponding physiological parameter 226 of the current physiological data 202. Therefore, each parameter 218, 226 are compared sample 222 to sample 224. The actual correspondence on a sample-by-sample basis can be determined in a number of ways. The correspondence between samples can be determined using a regression or other statistical measure such as known error calculations or an R² value. These correspondence determinations can then be converted into a correspondence rating. The correspondence rating can be defined as a series of bins or thresholds that qualitatively describe the determined correspondence. The placement of each of the sample specific correspondences 228 into these bins may further utilize fuzzy logic or weighting algorithms that place additional emphasis on some samples over others.

This correspondence analysis is performed for each of the individual parameters 218 of the historical record 216 to produce a plurality of sample specific correspondences 228.

Next, at 230, the individual parameters 218 of the historical record 216 are compared to the individual parameters 226 of the current patient data 202 on a parameter-by-parameter basis which includes the sample specific correspondences 228 to create a parameter specific correspondence 232 for each of the individual parameters.

In an embodiment wherein the sample specific correspondences 228 are calculated, the parameter specific correspondences 232 can be an average correspondence across all of the sample specific correspondences 228 from the individual parameters. Alternatively, the parameter specific correspondence 232 can be a weighted average or a median value of the sample specific correspondences 228 for the individual parameter. Similar to the sample specific correspondences 228, the parameter specific correspondences may be related as a correspondence rating that places the correspondence of the individual parameter from the historical record to the individual parameter from the current patient data into a bin or threshold based upon the correspondence level.

In an alternative embodiment, wherein no sample specific correspondence 228 is calculated for each sample of the individual parameter, then the comparison of the individual parameter at 230 would resemble the sample-specific comparison 220 as described above. In such an embodiment, the calculated correspondence could be determined using regression, curve fitting, or morphology detection techniques, among others.

At 234, each historical record 216 of the similar patient subset 204 is compared holistically to the current physiological data 202. If parameter specific correspondences 232 as described are available, the comparison at 234 can rely upon the averaging, weighted averaging, median value, or other statistical analysis of the parameter specific correspondences 213 to arrive at a case specific correspondence 210. Similar to the other correspondences as described above, the case specific correspondence 210 is converted into a correspondence rating defined by bins or thresholds that representatively denote the match quality between the historical record 216 and the current patient physiological data.

In one embodiment, the case specific correspondence is reported on a scale or 0-5 wherein 5 is the best match and 1 is the worst match, while the rating of 0 is used to indicate a situation wherein a correspondence is invalid. Such an invalidation of a correspondence determination may result from missing parameter data, or incomplete parameter data. In one exemplarily embodiment, if the trend length for the patient outcome prediction is temporally longer than the amount of physiological data in the historical record for that parameter, than an incomplete determination of correspondence between the current physiological data and the historical record may be determined. However, a person of ordinary skill in the art will recognize alternative situations when a case specific correspondence 210 may be identified to be invalid.

As noted above, in the embodiment of the process 200 as disclosed herein, the similar patient subset 204 is divided between critical outcome records 212 and recovery outcome records 214. At 236, the case specific correspondences 210 for each of the critical outcome records 212 are aggregated to arrive at an overall correspondence between the current patient data and a critical outcome at 238. Similarly, the case specific correspondences 210 for each of the recovery outcome records 214 are aggregated at 236 to arrive at an overall correspondence between the current patient data and a recovery outcome at 238.

The overall correspondence 238 between the current patient data and the critical outcome 212 or recovery outcome 214 can be aggregated in a similar manner as described above with the calculation of the other correspondences. Similarly, the overall correspondence 238 may include in embodiments the numerical average of the case specific correspondences 210 for the critical outcome records and the recovery outcome records, respectively. These overall correspondences 238 for the critical outcome and the recovery outcome may be a weighted average that places more emphasis on the number of highest and lowest quality correspondences (e.g. “5” and “1”; or “0”). Similarly, a median case specific correspondence 210 for the two outcomes may be used, as well as other manners of reporting the correspondences in aggregate.

Finally, at 240, a patient outcome prediction is made by selecting the outcome from the critical outcome and recovery outcome to which the current patient data has a greater overall correspondence 238.

In an alternative embodiment, both the critical outcome and the recovery outcome are reported with their associated overall correspondences 238. In this embodiment (not depicted), the clinician is informed of the correspondences between the two opposing outcomes before making a decision as to any changes in the treatment of the patient. The reporting of the patient outcome prediction with the overall correspondence 238 may include both the reporting of the aggregate overall correspondence 238 or may alternatively report the classification of each of the case specific correspondences 210 for each of the patient outcomes as reported in the thresholds or bins.

Some embodiments disclosed herein can be implemented through the use of a computer, in such computer-implemented inventions, the technical effect of such embodiments is to provide a prediction of the outcome of the patient based upon available physiological information.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A non-transient computer readable medium programmed with computer readable code that upon execution by a processor causes the processor to perform actions to notify a clinician of a predicted outcome of a patient, comprising:
receive current physiological information from the patient;
retrieve a similar patient subset, the similar patient subset comprising a plurality of historical records, each historical record of the similar patient subset comprising historical physiological information and a historical outcome, the historical outcome being at least a first outcome or a second outcome;
compare the current physiological information from the patient to the historical physiological information of each of the historical records;
rate a correspondence between the current physiological information from the patient and the historical physiological information of each of the historical records;
separate the historical records of the similar patient subset based upon the historical outcome in each of the historical records;
select between the first outcome and the second outcome based upon the ratings of the correspondences; and
present a notification indicative of the selected first or second outcome.

2. The computer readable medium of claim 1, wherein the execution of the computer readable code further causes the processor to:
receive demographic information about the patient;
receive diagnosis information about the patient;
filter a database comprising a plurality of historical records to create the similar patient subset out of the plurality of historical records, each historical record of the plurality comprises historical demographic information, historical physiological information, and a historical outcome, wherein the database is filtered to select historical records from the plurality in which the demographic information about the patient is similar to the historical demographic information.

3. The computer readable medium of claim 2, wherein the demographic information comprises patient sex, age, height, weight, and race.

4. The computer readable medium of claim 3, wherein the execution of the computer readable code further causes the processor to filter the similar patient subset based upon the diagnosis information about the patient to limit the historical physiological information used from each of the historical records of the similar patient subset, to only historical physiological information related to the diagnosis information about the patient.

5. The computer readable medium of claim 1, wherein the historical outcome indicates either a critical outcome or a recovery outcome, wherein the first outcome is the critical outcome and the second outcome is the recovery outcome.

6. The computer readable medium of claim 5, wherein the execution of the computer readable code further causes the processor to:
separate the similar patient subset into a first group comprising historical records that comprise a recovery outcome, and a second group comprising historical records that comprise a critical outcome;
wherein the first outcome is defined from the historical records of the first group and the second outcome is defined from the historical records of the second group.

7. The computer readable medium of claim 6, wherein the execution of the computer readable code further causes the processor to rate the correspondence between the current physiological information from the patient and the historical physiological information of the first group by rating a correspondence between the current physiological information and the historical physiological information of each of the historical records of the first group.

8. The computer readable medium of claim 7, wherein the execution of the computer readable code further causes the processor to rate the correspondence between the current physiological information from the patient and the historical physiological information of the second group by rating a correspondence between the current physiological information and the historical physiological information of each of the historical records of the second group.

9. The computer readable medium of claim 8, wherein the execution of the computer readable code further causes the processor to select between the critical outcome and the recovery outcome based upon which of the first and second groups have a highest mean rated correspondence between the current physiological information and the historical physiological information.

10. The computer readable medium of claim 8, wherein the execution of the computer readable code further causes the processor to select between the critical outcome and the recovery outcome based upon which of the first and second groups have a highest median rated correspondence between the current physiological information and the historical physiological information.

11. The computer readable medium of claim 1, wherein the execution of the computer readable code further causes the processor to:
receive a trend length;
filter the historical physiological information of the similar patient subset to only include historical physiological information within the trend length of the historical outcome.

12. A non-transient computer readable medium programmed with computer readable code that upon execution by a processor causes the processor to perform actions to notify a clinician of a predicted outcome of a patient, comprising:
receive demographic information about the patient;
receive diagnosis information about the patient;
filter a database comprising a plurality of historical records to create a similar patient subset, each historical record of the plurality comprising historical demographic information, historical physiological information, and a historical outcome wherein the historical outcome is either a critical outcome or a recovery outcome, wherein the similar patient subset comprises historical records from the plurality in which the demographic information about the patient is similar to the demographic information in each of the historical records of the similar patient subset;
filter the similar patient subset based upon the diagnosis information about the patient to limit the historical physiological information used from each of the historical records of the similar patient subset;
separate the similar patient subset into a critical outcome group and a recovery outcome group based upon the whether the historical record had a critical outcome or a recovery outcome;
define a critical outcome based upon the historical physiological information of the historical records of the critical outcome group;
define a recovery outcome based upon historical physiological information of the historical records of the recovery outcome group;
receive current physiological information from the patient;
compare the current physiological information from the patient to the critical outcome and the recovery outcome;
rate a correspondence between the current physiological information from the patient and each of the critical outcome and the recovery outcome;
select between the critical outcome path and the recovery outcome path based upon the ratings of the correspondences; and
present a notification indicative of the selected critical outcome path or the recovery outcome path.

13. The computer-readable medium of claim 12, wherein the correspondence between the current physiological information and each of the critical outcome and the recovery outcome is an overall correspondence between all of the historical records of the critical outcome group and the recovery outcome group.

14. The computer-readable medium of claim 13, wherein the overall correspondence is calculated from a plurality of case specific correspondences, each case specific correspondence of the plurality being a correspondence between the current physiological information and historical physiological information of one historical record of the similar patient subset.

15. The computer-readable medium of claim 14, wherein each case specific correspondence is calculated from a plurality of parameter specific correspondences, each parameter specific correspondence of the plurality being a correspondence between the historical physiological data of a historical record and the current physiological information.

16. The computer-readable medium of claim 15, wherein each parameter specific correspondence is calculated from a plurality of sample specific correspondences, each sample specific correspondence of the plurality being a correspondence between each sample of the historical physiological data and each sample of the current physiological information.

17. A system for predicting an outcome of a patient, the system comprising:
a match candidate database stored on a computer readable medium, the match candidate database comprising a plurality of historical records, wherein each historical record of the plurality comprises historical physiological information and a historical outcome;
a graphical display configured to present a notification of a predicted outcome of the patient; and
a processor communicatively connected to the match candidate database and the graphical display, the processor compares the physiological information from the patient with the historical physiological information from the plurality of historical records and rates a correspondence between the physiological information from the patient and the historical records, the processor uses the rated correspondence to determine a predicted outcome of the patient;
wherein the processor operates the graphical display to present the notification of the predicted outcome of the patient and an associated correspondence used to determine the predicted outcome of the patient.

18. The system of claim 17, further comprising a patient monitor communicatively connected to the patient, the patient monitor acquires the physiological information from the patient such that the physiological information from the patient is current physiological information.

19. The system of claim 18, wherein the processor retrieves a similar patient subset of historical records from the match candidate database, and the processor rates the correspondence between the historical records of the similar patient subset and the current physiological information; and
wherein the processor determines the predicted outcome of the patient by identifying the historical outcome of each of the historical records of the similar patient subset and selecting the historical outcome that results in a higher correspondence with the current physiological information.

20. The system of claim 19, further comprising a historical records database that comprises a plurality of historical records;
wherein the processor further receives patient demographic information and the processor uses the patient demographic information to filter the historical records of the historical record database to select historical records for the similar patient subset and the processor stores the similar patient subset in the match candidate database.
